(19) United States
(12) Patent Application Publication
(10) Pub. No.: US 2019/0089693 A1
(43) Pub. Date: Mar. 21, 2019

(54) SYSTEMS AND METHODS FOR AUTHENTICATING INTERNET-OF-THINGS DEVICES

(71) Applicants: Jing Ding, Saratoga, CA (US); Victoria S. Ding, Stanford, CA (US)

(72) Inventors: Jing Ding, Saratoga, CA (US); Victoria S. Ding, Stanford, CA (US)

(21) Appl. No.: 15/711,100

(22) Filed: Sep. 21, 2017

(51) Int. Cl. H04L 29/06; G06F 21/44

(52) U.S. Cl. CPC H04L 63/0807; H04W 12/06; G06F 21/44; H04L 63/0876

(57) ABSTRACT

Systems and methods for authenticating Internet-of-Things devices are disclosed. According to certain embodiments, the method includes broadcasting, via a communication network, a connection token. The method also includes receiving, via the communication network, a pairing request from a second device receiving the connection token. The method also includes providing, via the communication network, identification information of the first device to the second device. The method further includes receiving, from the second device, an authentication token generated based on the identification information of the first device.

### TECHNICAL FIELD

The present disclosure relates generally to Internet of Things (IoT) device authentication, and more particularly, to systems and methods for provisioning authentication information, such as trusted pins and tokens, for authenticating IoT devices.

### BACKGROUND

Increasing proliferation of electronic devices, such as smart home appliances, wearable devices, mobile phones, cameras, vehicles, drones, media players, etc., continuously opens up new services that benefit people's daily life. These service-providing devices (hereinafter referred to as “target devices”) may be connected to form an Internet of Things (IoT). The IoT allows users to remotely manage (e.g., access, monitor, and/or control) the target devices through terminals and/or servers that are also connected to the IoT.

Often, communication via the IoT needs to be authenticated. In many circumstances, it is desirable for a target device to only accept and/or process commands from an authenticated terminal/server, to prevent unauthorized users from using the target device for any undesired activities. For example, the target device may be a network camera installed at a private premise. In the absence of a proper authentication mechanism, a hacker may, e.g., hijack the network camera to spy on the premise.

It may be also desirable for a terminal/server to only accept and/or process messages from an authenticated target device, to protect the terminal/server from attacks originated from unknown network locations. For example, using signal spoofing technology, unauthorized users may send to the terminal/server fake signals that appear to originate from a legitimate target device but actually contain malware. Without proper signal authentication, the terminal/server may be deceived and/or harmed by the malware.

As such, before the target device and terminal/server communicate, authentication information, such as authentication pins or tokens, may need to be created and provided to the target device and terminal/server, for authenticating subsequent data exchange between the target device and terminal/server.

Conventional methods for provisioning authentication information often require users to input certain information, such as account information, identification information of the target device or terminal, or user passwords, in the target device and/or terminal. However, many target devices, such as a lamp or a camera, have no user interface or only have limited capabilities for user-machine interaction. Such devices are known in the field as “headless devices.” It may be cumbersome to input information to and receive feedback from a headless device. For example, a lamp may have no display or keyboard, and thus a user cannot directly enter a user password in the lamp.

Moreover, even if the target device and terminal provide adequate input and output means, it is tedious and error prone for users to manually input information. In addition, the conventional methods for provisioning authentication information also rely on a cloud server (e.g., the server used for managing the target device) for generating the authentication pin or token based on the inputted information. As such, in the absence of the cloud server, it is impossible to generate the authentication pin or token by the target device and terminal alone.

The disclosed systems and methods for provisioning authentication information of IoT devices are directed to mitigating or overcoming one or more of the problems set forth above and/or other problems in the prior art.

### SUMMARY

One aspect of the present disclosure is directed to an authentication method for a first device. The method includes broadcasting, via a communication network, a connection token. The method also includes receiving, via the communication network, a pairing request from a second device receiving the connection token. The method also includes providing, via the communication network, identification information of the first device to the second device. The method further includes receiving, from the second device, an authentication token generated based on the identification information of the first device.

Another aspect of the present disclosure is directed to a system including a memory configured to store a set of instructions; and a processor configured to execute the set of instructions to perform an authentication method for a first device connected with a second device via a communication network. The method includes broadcasting, via the communication network, a connection token. The method also includes receiving, via the communication network, a pairing request from a second device receiving the connection token. The method also includes providing, via the communication network, identification information of the first device to the second device. The method further includes receiving, from the second device, an authentication token generated based on the identification information of the first device.

Yet another aspect of the present disclosure is directed to a non-transitory computer-readable medium storing instructions which, when executed, cause one or more processors to perform an authentication method for a first device. The method includes broadcasting, via a communication network, a connection token. The method also includes receiving, via the communication network, a pairing request from a second device receiving the connection token. The method also includes providing, via the communication network, identification information of the first device to the second device. The method further includes receiving, from the second device, an authentication token generated based on the identification information of the first device.

### BRIEF DESCRIPTION OF THE DRAWINGS

FIG. 1 is a schematic diagram illustrating a system for provisioning authentication information of Internet-of-Things (IoT) devices, according to an exemplary embodiment;

FIG. 2 is a block diagram of the system shown in FIG. 1, according to an exemplary embodiment;

FIG. 3 is a schematic diagram illustrating a first exemplary method for provisioning authentication information of IoT devices, according to an exemplary embodiment;

FIG. 4 is a flowchart of the first exemplary method for provisioning authentication information of IoT devices, according to an exemplary embodiment;

FIG. 5 is a schematic diagram illustrating a second exemplary method for provisioning authentication information of IoT devices, according to an exemplary embodiment;

FIG. 6 is a flowchart of the second exemplary method for provisioning authentication information of IoT devices, according to an exemplary embodiment; and

FIG. 7 is a flowchart of a method for authenticating IoT devices, according to an exemplary embodiment.

### DETAILED DESCRIPTION

This disclosure is generally directed to systems and methods for provisioning authentication information of Internet-of-Things (IoT) devices. Consistent with the disclosed embodiments, before a terminal can access, monitor, and/or control a target device, the terminal needs to be paired with the target device. The disclosed methods may be performed before or during the pairing operation, to generate and provision authentication information that can be used for authenticating the communication between the terminal device and the target device after the pairing.

In particular, according to the disclosed embodiments, a first terminal may include a management agent configured to generate authentication information directly or via a management server. The management agent may also provide the generated authentication information to a target device. The authentication information may be in the form of an authentication pin or an authentication token, and may be used to authenticate the communication among the target device, the first terminal, and/or the management server. The management agent may be implemented as hardware, software, or a combination thereof.

Specifically, in some embodiments, the first terminal may pair with the target device and obtain identification information of the target device, such as a media control access (MAC) address associated with the target device. The first terminal may then generate a trusted pin based on the MAC address and provide the trusted pin to the target device.

In some embodiments, the first terminal may relay the MAC address to the management server, which may generate a trusted token based on the MAC address and provide, via the first terminal, the trusted token to the target device.

In some embodiments, a second terminal may obtain the trusted pin and/or trusted token from the first terminal and/or management serve, and manage the target device based on the trusted pin and/or trusted token.

The disclosed systems and methods minimize the requirement for a user input into the target device, and thus are suitable for target devices that have no user interface (i.e., headless devices) or only have limited capabilities for user-machine interaction.

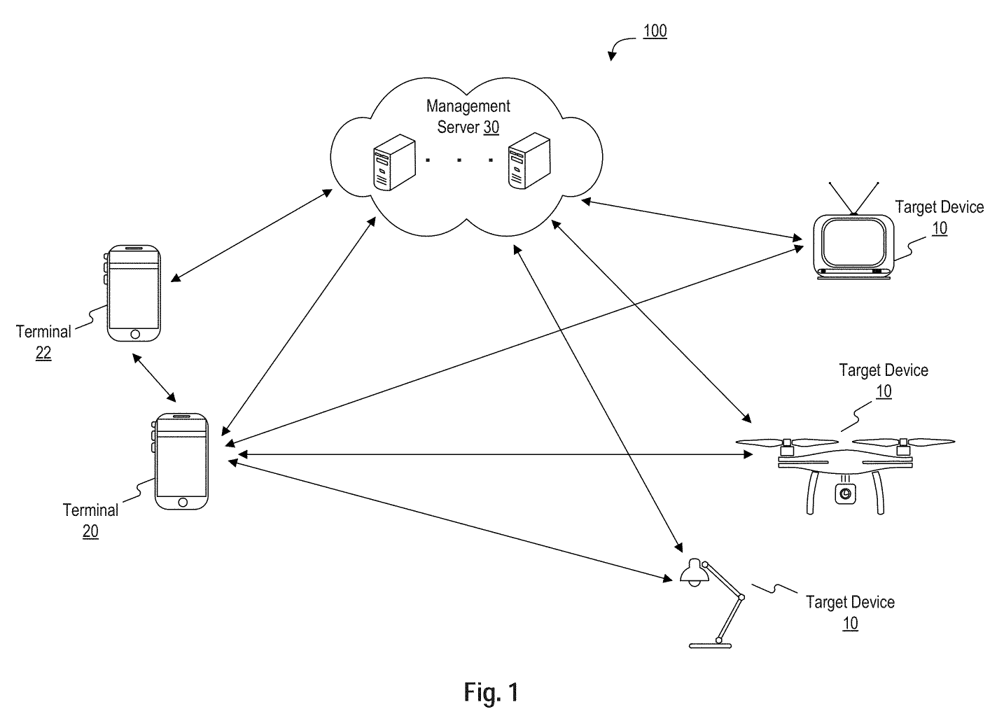

FIG. 1 is a schematic diagram illustrating a system 100 for provisioning authentication information of IoT devices, according to an exemplary embodiment. Referring to FIG. 1, system 100 may include one or more of a target devices 10, a terminal 20, a terminal 22, and a management server 30. Target device 10 may be any device that is connected to an IoT and thus can be remotely managed (e.g., accessed, monitored, and/or controlled) by terminals 20 and/or management server 30.

Target device 10 may be a device with certain computing and/or communication capabilities, such as a smart home appliance (e.g., a lamp, a television, an air conditioner, an air purifier, a socket, a washing machine, etc.), a network camera or Internet protocol (IP) camera, a wearable device, a drone, a connected vehicle, a robot, etc. In some embodiments, target device 10 may be a headless device that has no user interface or only have limited capabilities for user-machine interactions.

Target device 10 may be managed by terminal 20 directly or via management server 30. For example, if target device 10 is a lamp, terminal 20 may remotely turn on or off the lamp, and/or change the color of the light emitted by the lamp. As another example, if target device 10 is a TV, terminal 20 may remotely turn on or off the TV, and/or change the channel currently played by the TV. As another example, if target device 10 is a drone, terminal 20 may remotely control the rotation speed of the drone's propellers and its flight route. As another example, if target device 10 is an IP camera, terminal 20 may remotely turn on the IP camera and receive video streaming from the IP camera.

Terminal 20 may be an electronic device with computing capabilities, such as a mobile phone, a tablet computer, a personal computer, a wearable device (e.g., a smart watch), a personal digital assistant (PDA), a remote controller, exercise equipment, an ebook reader, a MP4 (Moving Picture Experts Group Audio Layer IV) player, etc. In the disclosed embodiments, terminal 20 may be paired with target device 10 and provide an authentication pin or an authentication token to target device 10. Target device 10 and terminal 20 may use the authentication pin or token to authenticate data exchanged between each other, such that terminal 20 may manage target device 10 via a secured communication channel.

Consistent with the disclosed embodiment, terminal 20 may generate the authentication pin or token by itself or via management server 30. Management server 30 may be a general-purpose computer, a mainframe computer, or any combination of these components. Management server 30 may be implemented as a server, a server cluster consisting of a plurality of servers, or a cloud computing service center. The disclosed functions of management server 30 may be performed by one server or multiple servers. Management server 30 may be operated by an IoT service provider or a manufacturer/supplier of target device 10. In some embodiments, management server 30 may receive a request from terminal 20 and generate the authentication pin or token based on the request. Management server 30 may then provide the authentication pin or token to terminal 20.

In the disclosed embodiments, management server 30 may facilitate information exchange between target device 10 and terminal 20. For example, when target device 10 and terminal 20 are located in the same local network, target device 10 and terminal 20 may communicate with each other directly or via a router, without the assistance of management server 30. However, when target device 10 and terminal 20 are located in different networks, e.g., in different countries, terminal 20 may need to first send control commands to management server 30, which then relays the commands to target device 10. Similarly, target device 10 may send data to terminal 20 via management server 30.

In some embodiments, system 100 may include other terminals, for example, terminal 22. Terminal 22 may have a configuration similar to that of terminal 20. Terminal 22 may obtain the authentication pin or token from terminal 20, and then pair with target device 10 using the authentication pin or token. After the pairing is formed, terminal 22 may manage (e.g., access, monitor, and/or control) target device 10. Similarly, the authentication pin or token may be used to authenticate the communication between target device 10 and terminal 22.

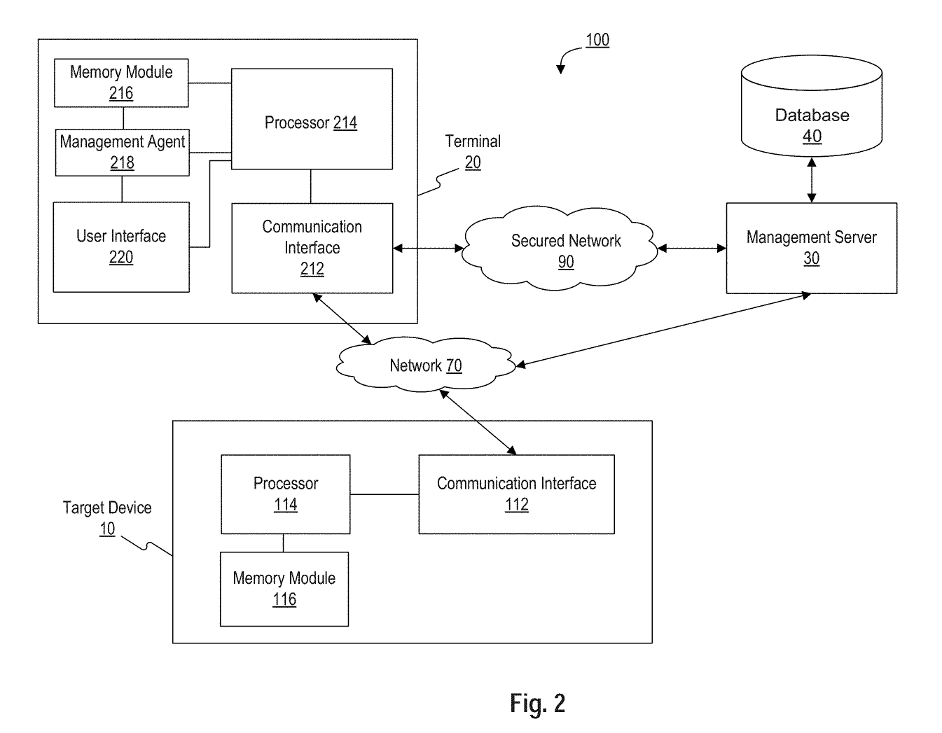

FIG. 2 is a block diagram of system 100 of FIG. 1, according to an exemplary embodiment. Again, system 100 may include target device 10, terminal 20, and management server 30. Referring to FIG. 2, target device 10 may include a communication interface 112, a processor 114, and a memory module 116. These units may be configured to transfer data and send or receive instructions between or among each other.

Communication interface 112 can access a wireless network based on one or more communication standards, such as WiFi, LTE, 2G, 3G, 4G, 5G, etc. In one exemplary embodiment, communication interface 112 may include a near field communication (NFC) module to facilitate short-range communications between target device 10 and other devices. In other embodiments, communication interface 112 may be implemented based on a radio-frequency identification (RFID) technology, an infrared data association (IrDA) technology, an ultra-wideband (UWB) technology, a Bluetooth® technology, or other technologies.

Communication interface 112 may be configured to consolidate signals it receives from other devices, e.g., terminal 20 and management server 30, and relay the signals to processor 114. Processor 114 may include any appropriate type of general purpose or special-purpose microprocessor, digital signal processor, or microprocessor. Processor 114 may be configured as a separate processor module dedicated to performing the disclosed methods for provisioning authentication information. Alternatively, processor 114 may be configured as a shared processor module for performing other functions of target device 10 unrelated to the disclosed methods for provisioning authentication information. In the exemplary embodiments, processor 114 may execute computer instructions (program codes) stored in memory module 116, and may perform functions in accordance with exemplary techniques described in this disclosure. Details about the exemplary functions of processor 114 will be described below in relation to the disclosed methods for provisioning authentication information.

Memory module 116 may include any appropriate type of mass storage provided to store any type of information that processor 114 may need to operate. Memory module 116 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory module 116 may be configured to store one or more computer programs that may be executed by processing unit 114 to perform the disclosed methods for provisioning authentication information.

Still referring to FIG. 2, terminal 20 may include a communication interface 212, a processor 214, a memory module 216, a management agent 218, and a user interface 220. These units may be configured to transfer data and send or receive instructions between or among each other. The structures of communication interface 212, processor 214, and memory module 216 are similar to those of communication interface 112, processor 114, and memory module 116, respectively.

Moreover, management agent 218 may be a module dedicated to performing some or all steps of the disclosed methods for provisioning authentication information. Management agent 218 may be configured as hardware, software, or a combination thereof. For example, management agent 218 may be implemented as computer codes stored in memory module 216 and executable by processor 214. As another example, management agent 218 may be implemented as a special-purpose processor, such as an application-specific integrated circuit (ASIC), dedicated for performing the disclosed methods for provisioning authentication information. As yet another example, management agent 218 may be implemented as an embedded system or firmware.

Additionally, user interface 220 may include a display panel. The display panel may include a liquid crystal display (LCD), a light-emitting diode (LED), a plasma display, a projection, or any other type of display, and may also include microphones, speakers, and/or audio input/outputs (e.g., headphone jacks) or may be coupled to an audio system of terminal 20.

User interface 220 may also be configured to receive input or commands from the user. For example, the display panel may be implemented as a touch screen to receive input signals from the user. The touch screen includes one or more touch sensors to sense touches, swipes, and other gestures on the touch screen. The touch sensors may not only sense a boundary of a touch or swipe action, but also sense a period of time and a pressure associated with the touch or swipe action. Alternatively or in addition, user interface 220 may include other input devices such as keyboards, buttons, joysticks, and/or tracker balls. User interface 220 may be configured to send the user input to processor 214.

Still referring to FIG. 2, management server 30 may include one or more components similar to those included in target device 10 and terminal 20, details of which are not repeated here. Moreover, system 100 may include a database 40 for storing authentication information (e.g., authentication pin or token, etc.) associated with target devices, e.g., target device 10. Database 40 may also store information regarding pairing relationships between target devices and terminals, e.g., the pairing between target device 10 and terminal 20. Database 40 may be hosted by management server 30 or a separate computer. Database 40 may be constantly updated by management server 30 to reflect the change of the authentication information and the pairing relationships.

Still referring to FIG. 2, target device 10, terminal 20, and management server 30 may communicate via a network 70. Network 70 may be any type of wired or wireless network that may allow transmitting and receiving data. For example, network 70 may be a wired network, a local wireless network (e.g., Bluetooth®, Zigbee, WiFi, near field communications (NFC), etc.), a cellular network, an Internet, or the like, or a combination thereof.

Moreover, terminal 20 and management server 30 may communicate via a secured network 90. Secured network 90 may be used to transmit highly confidential data, such as authentication pins or tokens. Various mechanisms may be implemented to ensure data security in secured network 90. For example, secured network 90 may be a private network that can only be accessed by authorized users. For another example, secured network 90 may be a direct link between terminal 20 and management server 30. For another example, data transmitted over secured network may be encrypted. In the disclosed embodiments, network 70 and secured network 90 may be implemented as the same network or different networks.

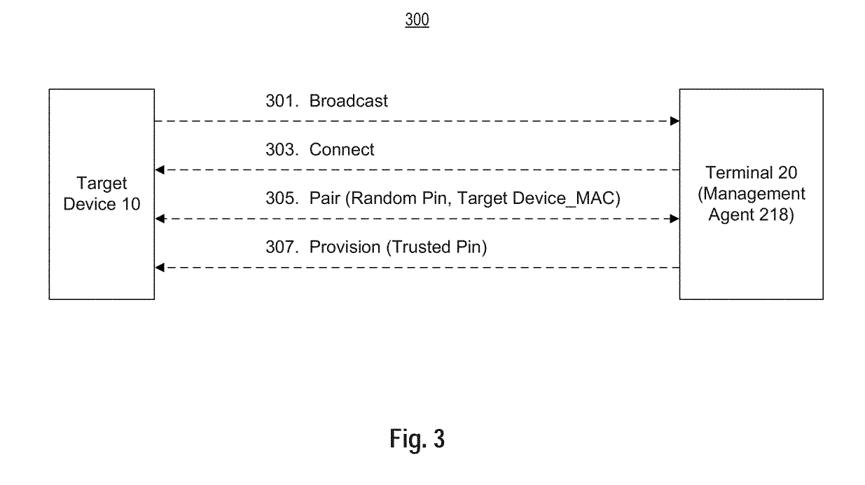

FIG. 3 is a schematic diagram illustrating a method 300 for provisioning authentication information of IoT devices, according to an exemplary embodiment. As shown in FIG. 3, method 300 may be performed by target device 10 and terminal 20 (via management agent 218), without the participation of a server (e.g., management server 30).

Referring to FIG. 3, in step 301, target device 10 may broadcast an initial connection token via a local network, such as network 70. In step 303, upon receiving and recognizing the initial connection token, terminal 20 may connect to target device 10. In step 305, target device 10 and terminal 20 may exchange respective identification information to form a pairing relationship. Specifically, terminal 20 may transmit a pairing request to target device 10. The pairing request may include a random pin used for identifying the pairing between target device 10 and terminal 20. Target device 10 may then accept the pairing request and return identification information of target device 10, for example, a media control access (MAC) address associated with target device 10, to terminal 20. This way, terminal 20 can be paired with target device 10, and future communication between target device 10 and terminal 20 is enabled. In step 307, terminal 20 may generate a trusted pin associated with target device 10, based on the identification information of target device 10, and transmit the trusted pin to target device 10. Afterwards, target device 10 and terminal 20 may use the trusted pin for authenticating the communication between themselves. For example, the trusted pin may be inserted in or otherwise encoded in the data packets exchanged between target device 10 and terminal 20 for authentication purpose.

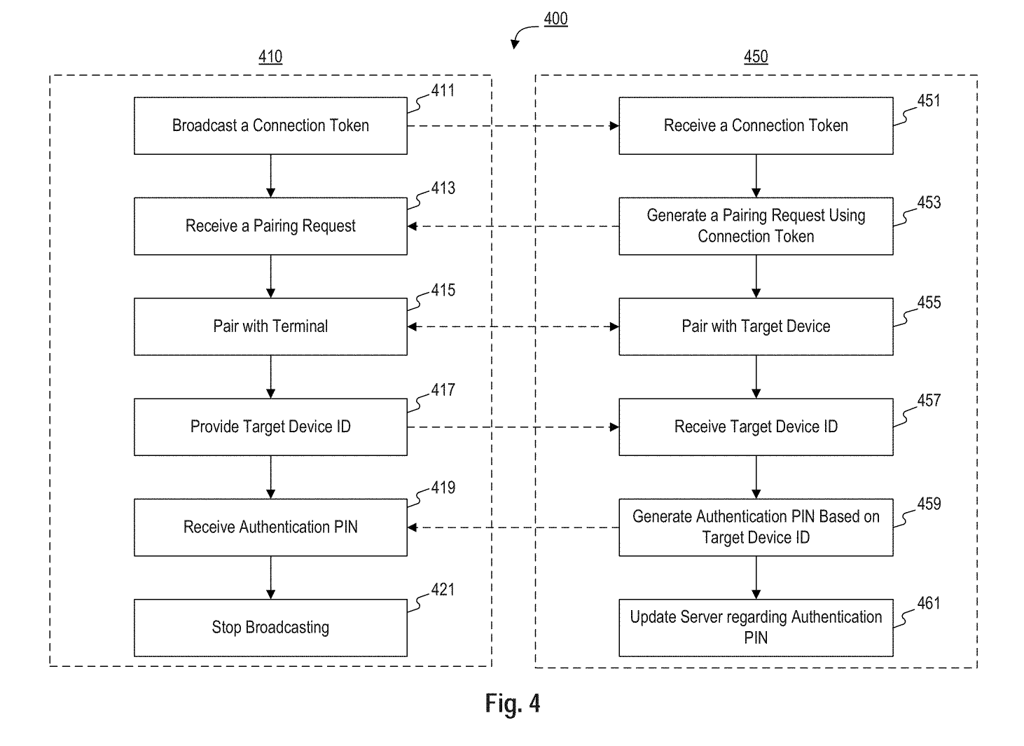

Next, details regarding the implementation of method 300 will be described in reference to FIG. 4. FIG. 4 is a flowchart of a method 400 for provisioning authentication information of IoT devices, according to an exemplary embodiment. Referring to FIG. 4, method 400 may include a process 410 performed by an IoT device (e.g., target device 10), and a process 450 performed by a terminal (e.g., terminal 20 with management agent 218). Consistent with the disclosed embodiments, during the provisioning of the authentication information, target device 10 and terminal 20 may be located in the same local network, e.g., network 70, while after the provisioning terminal 20 may be moved to other networks and remotely manage target device 10 using the authentication information.

Consistent with the disclosed amendments, the implementation of process 410 does not require target device 10 to have a sophisticate user interface. For example, process 410 may be initiated by turning on target device 10, pressing a button on target device 10, etc. In step 411, target device 10 may broadcast a connection token, which can be used by a device receiving the connection token to form a connection with target device 10. In some embodiments, the connection token may indicate MAC address, service set identifier (SSID), device type information, and/or IP address of target device 10. Target device 10 may encode the connection token into radio signals, sound signals, light signals, etc., and broadcast these signals in a local network (e.g., network 70).

For example, target device 10 may broadcast the connection token via Bluetooth® advertisement. Specifically, target device 10 may generate advertising packets enclosing the connection token and transmit the advertising packets through one or more predetermined advertising channels. Other devices including terminal 20 may listen to these predetermined channels for the advertising packets.

As another example, if target device 10 and terminal 20 have IP multicast functions, target device 20 may write the connection token into one or more multicast packets and send the multicast packets using the multicast Domain name System (mDNS) protocol. Alternatively, target device 20 may write device information such as device type, MAC address, IP address, into one or more multicast packets. Other devices including terminal 20 may scan a plurality of multicast channels to detect the multicast packets.

As yet another example, target device 10 may also broadcast the connection token via acoustic and/or light signals. For example, target device 10 may broadcast, via a speaker, an acoustic wave encoding the connection token, or emit, via one or more LED lights, a light pattern encoding the connection token. Devices surrounding target device 10 may receive the sound wave and/or light pattern, and decode the connection token.

While process 410 is initiated, a user may also activate management agent 218 of terminal 12, to initiate process 450. For example, in some embodiments, management agent 218 may be implemented as a mobile application installed on terminal 20. As such, a user may initiate process 450 by opening the mobile application. After the initiation, terminal 20 may scan various broadcast channels to detect the connection token. Upon receiving the connection token (step 451), terminal 20 may recognize that target device 10 is ready for pairing and thus generate a paring request using the connection token (step 453). The paring request may include the connection token, identification information of terminal 20, and a random pin. The identification information of terminal 20 may be a unique ID associated with the management agent 218. The random pin is used for identify the pairing between target device 10 and terminal 20. For example, the random pin may be a random synchronous code generated by terminal 20, configured to initiate synchronization between target device 10 and terminal 20.

Subsequently, terminal 20 may transmit the pairing request to target device 10. Upon receiving the pairing request (step 413), target device 10 may verify the connection token in the pairing request. If the verification is successful, target device 10 may return a pairing-authorization response to terminal 20, and record the random pin as an identification of the pairing between target device 10 and terminal 20 (step 415). After receiving the pairing-authorization response, terminal 20 may recognize that it has been successfully paired with target device 10 (step 455).

Once paired, target device 10 and terminal 20 may communicate with each other. In step 417, target device 10 may provide its identification information to terminal 20 via the newly formed communication channel. The identification information may be in various forms. For example, the identification information may be a MAC address of IoT device 10 or a component (e.g., a Bluetooth® module) of IoT device. As another example, the identification information may be a code preset by a manufacturer or retailer of IoT device 10.

Upon receiving the identification information of target device 10 (step 457), terminal 20 may generate an authentication pin based on the identification information (e.g., MAC address) of target device 10 (step 459). In the disclosed embodiments, terminal 20 may use any applicable method to generate the authentication pin. For example, terminal 20 may pre-store multiple authentication pins. Terminal 10 may randomly select a pre-stored authentication pin and associate it with the identification information of target device 10. As another example, terminal 20 may employ a pin-generating algorithm to generate the authentication pin based on the identification information of target device 10.

Terminal 20 may transmit the generated authentication pin to target device 10 via network 70. As such, both target device 10 and terminal 20 are provided with the authentication pin, and can use the authentication pin to authenticate the data exchanged between target device 10 and terminal 20. Accordingly, upon receiving the authentication pin (step 419), target device 10 may stop broadcasting the connection token (step 421).

As described above, processes 410 and 450 do not require the involvement of management server 30, and thus are suitable for cases where no cloud servers are available for providing the authentication pin to target device 10. Nevertheless, in some embodiments, after the authentication pin is generated, terminal 20 may perform an optional step 461 to update management server 30 with the authentication pin, a timestamp when the authentication pin is generated, the identification information of target device 10 (e.g., the MAC address associated with target device 10), and the identification information of terminal 20 (e.g., the unique ID of management agent 218). This way, management server 30 may provide the authentication pin to other terminals that need to be paired with target device 10. Moreover, when management server 30 is needed to facilitate the communication between target device 10 and terminal 20, such as when target device 10 and terminal 20 are located in two different networks (e.g., in different countries), management server 30 may use the authentication pin to authenticate the communication.

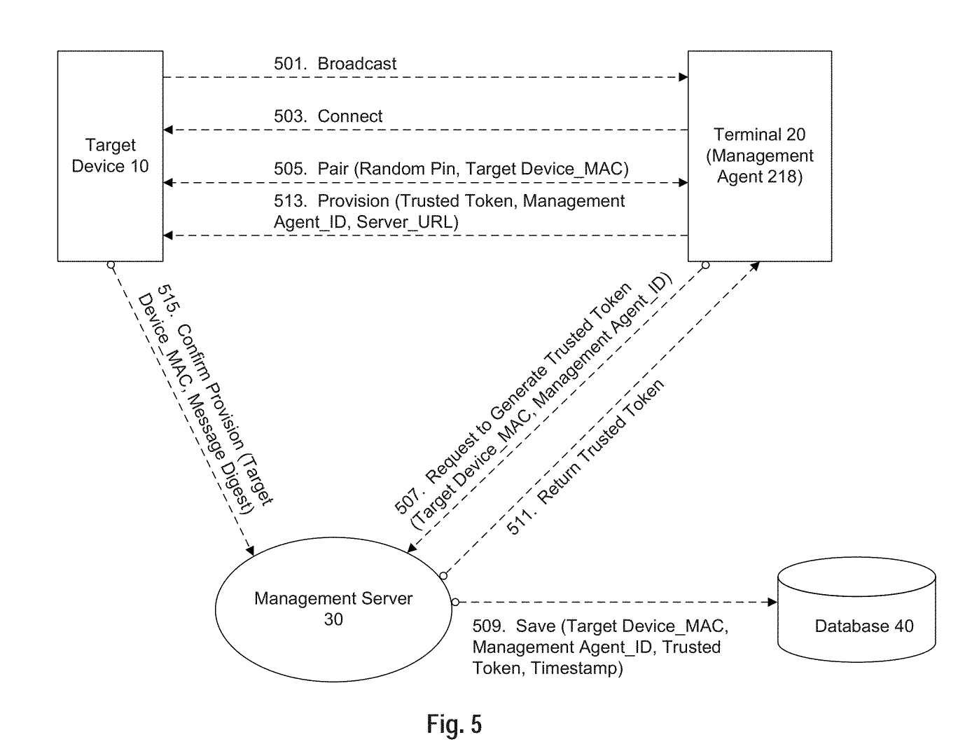

FIG. 5 is a schematic diagram illustrating a method 500 for provisioning authentication information of IoT devices, according to an exemplary embodiment. As shown in FIG. 5, unlike method 300, method 500 requires the participation of management server 30 and are performed by target device 10, terminal 20 (via management agent 218), and management server 30.

Referring to FIG. 5, in step 501, target device 10 may broadcast an initial connection token via a local network, such as network 70. In step 503, upon receiving and recognizing the initial connection token, terminal 20 may connect to target device 10. In step 505, target device 10 and terminal 20 may exchange respective identification information to form a pairing relationship. Specifically, terminal 20 may transmit a pairing request to target device 10. The pairing request may include a random pin used for identifying the pairing between target device 10 and terminal 20. Target device 10 may then accept the pairing request and return an identification of target device 10, for example, a MAC address associated with target device 10, to terminal 20. Steps 501-505 are similar to steps 301-305 shown in FIG. 3.

In step 507, terminal 20 may transmit, via a secured network (e.g., secured network 90), to management server 30 a request for generating a trusted token. The request may include the identification information of target device 10 (e.g., the MAC address associated with target device 10), the identification information of terminal 20 (e.g., the unique ID of management agent 218), and/or the random pin for identifying the pairing between target device 10 and terminal 20. In step 509, management server 30 may generate the trust token based on the MAC address associated with target device 10, and save the trusted token, the timestamp for generating the trusted token, and the identification information of target device 10 and terminal 20 in a database, e.g., database 40. In step 511, management server 30 may transmit the trusted token to terminal 20.

In step 513, terminal 20 may transmit the received trusted token, the identification information of terminal 20, and identification information (e.g., uniform resource locator (URL)) of management server 30 to target device 10. In step 515, upon receiving the trusted token, target device 10 may send a confirmation message to management server 30, indicating the token provisioning is successful. The confirmation message may include the identification information of target device 10 and may be sent along with a message digest. In some embodiments, the message digest is a numeric representation of the contents of confirmation message, created using a one-way hash function. Management server 30 may use the message digest to authenticate the confirmation message. For example, management server 30 may compare the hash value of the confirmation message to the message digest, to determine whether the confirmation message has been altered or intercepted.

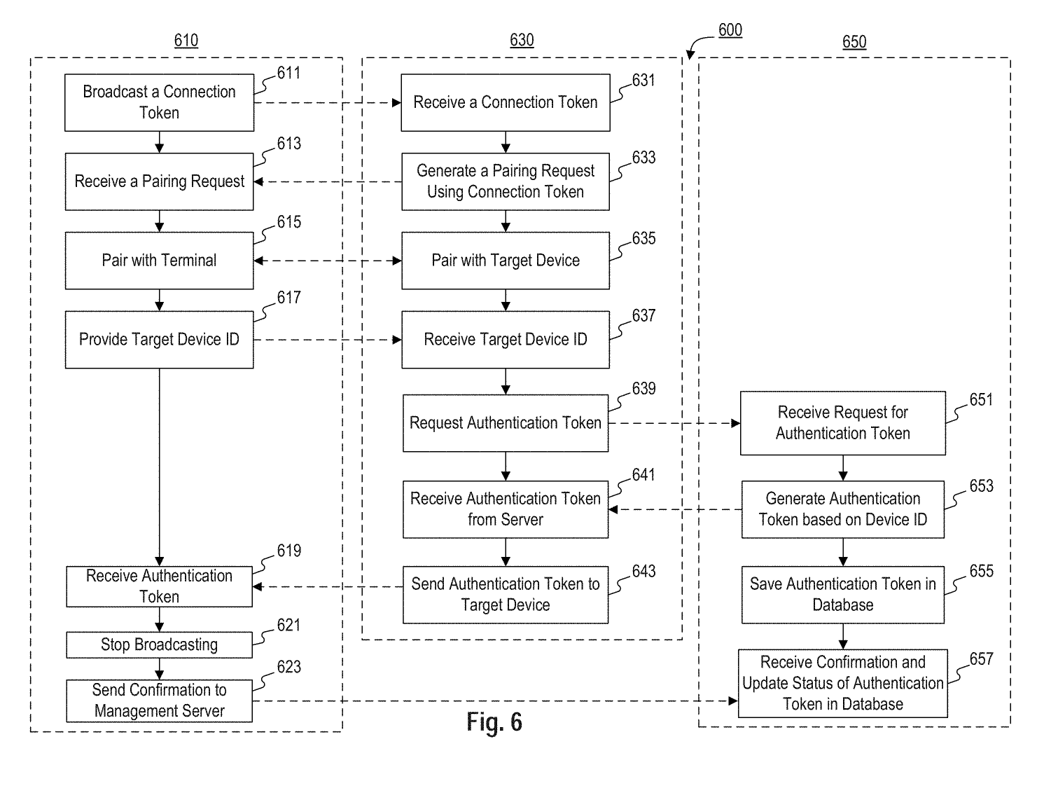

Next, details about implementing method 500 will be described in reference to FIG. 6. FIG. 6 is a flowchart of a method 600 for provisioning authentication information of IoT devices, according to an exemplary embodiment. Referring to FIG. 6, method 600 may include a process 610 performed by an IoT device (e.g., target device 10), a process 630 performed by a terminal (e.g., terminal 20 via management agent 218), and a process 650 performed by management server 30. Consistent with the disclosed embodiments, during the provisioning of the authentication information, target device 10 and terminal 20 may be located in the same local network, e.g., network 70, while management server 30 is remote from target device 10 and terminal 20. To ensure data security, terminal 20 and management server 30 may exchange data via a secured network, e.g., secured network 90.

Method 600 may start with step 611, at which target device 10 may broadcast a connection token via network 70. Terminal 20 may receive the connection token (step 631) and generate a pairing request using the connection token (step 633). Upon target device 10 receiving the pairing request (step 613), target device 10 and terminal 20 may pair with each other (steps 615, 635). Target device 10 then provide identification information of target device 10 to terminal 20. For example, the identification information of target device 10 may be a MAC address associated with target device 10. In the disclosed embodiments, steps 611-617 are similar to steps 411-417 (FIG. 4), respectively, and steps 631-637 are similar to steps 451-457 (FIG. 4), respectively.

Subsequently, in step 639, terminal 20 may transmit to management server 30 a request for authentication token. The request may include the identification information of target device 10 (e.g., the MAC address associated with target device 10) and the identification information of terminal 20 (e.g., the unique ID of management agent 218), to indicate the requested authentication token is used for communication between target device 10 and terminal 20.

Upon receiving the request for authentication token (step 651), management server 30 may generate an authentication token based on the identification information of target device 10 (step 653). In some embodiments, management server 30 may first generate an authentication pin associated with target device 10, and then convert the authentication pin into a token, i.e., a non-sensitive data element that has no extrinsic or exploitable meaning or value. The authentication token may comprise a data structure suitable for automatically transferring information between computer systems, such as an XML document, JSON object, or SOAP message. One of skill in the art would recognize that other data structures may be used without departing from the envisioned embodiments. Management server 30 may save the authentication token, the timestamp indicating when the authentication token is generated, and the identification information of target device 10 and terminal 20 in a database, e.g., database 40 (step 655). In some embodiments, the authentication token may be time limited, and thus management server 30 may further save the expiration time of the authentication token in database 40. In some embodiments, the authentication token saved in database 40 may include a status field configured to indicate the current state of the authentication token. For example, the status field may indicate whether the authentication token has been successfully provided to or received by target device 10, whether the authentication token has expired, etc. In some other embodiments, the status may be saved separately from the authentication token but linked to the authentication token.

Management server 30 may also provide the authentication token to terminal 30 via secured network 90. Upon receiving the authentication token from management server 30 (step 641), terminal 20 may transmit the authentication token, the identification information of terminal 20 (e.g., the unique ID of management agent 218), and the identification of management server 30 (e.g., the URL of management server 30) to target device 10 via network 70 (step 643).

After receiving the authentication token (step 619), target device 10 may stop broadcasting the connection token. As such, target device 10, terminal 20, and management server 30 are all provided with the authentication token and can use the authentication token to authenticate communication between target device 10 and terminal 20.

In some embodiments, in addition to stop broadcasting the connection token, target device 10 may further transmit a confirmation message to management server 30 (step 623). The confirmation message may be configured to notify management server 30 that the authentication token has been successfully received by target device 10. Correspondingly, in some embodiments, upon receiving the confirmation message from target device 10, management server 30 may update the status of the authentication token saved in database 40 to indicate that a confirmation message from target device 10 has been received (step 657).

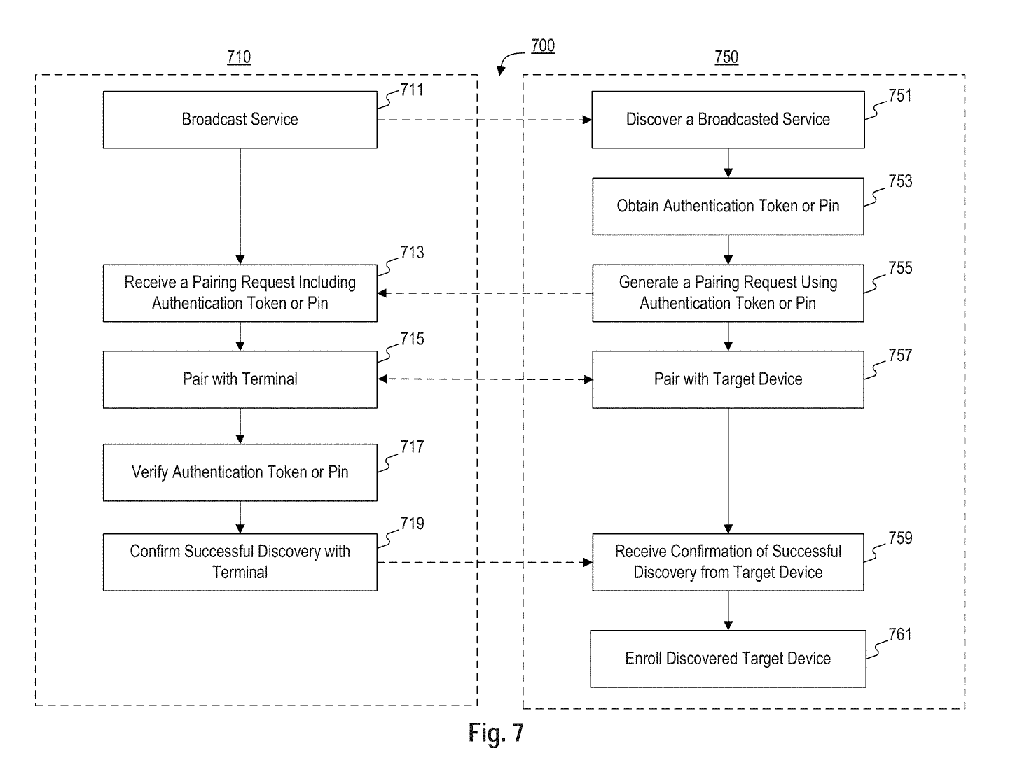

In the disclosed embodiments, after the authentication information associated with target device 10 is provided by terminal 20, the authentication information may be provided to additional terminals, e.g., terminal 22, which can then use the authentication information to manage target device 10. FIG. 7 is a flowchart of a method 700 for authenticating IoT devices, according to an exemplary embodiment. For example, method 700 may be used by terminal 22 to discover and manage target device 10, based on the authentication information associated with target device 10. Referring to FIG. 7, method 700 may include a process 710 performed by an IoT device (e.g., IoT device 10), and a process 750 performed by a terminal (e.g., terminal 22). In some embodiments, terminal 22 may include a management agent similar to management agent 218. The management agent may be configured to perform process 750.

In step 711, target device 10 may broadcast its service in a network, e.g., network 70. For example, when a user turns on target device 10 or press a designated button on target device, target device 10 may start to broadcast information, such as its MAC address, SSID, device type information, and/or IP address, using the mDNS protocol.

In step 751, terminal 22 may scan a plurality of multicast channels and discover the service of target device 10. After receiving and recognizing the information broadcasted by target device 10 in step 711, terminal 22 may also send an inquiry to target device 10 to obtain the MAC address of target device 10.

In step 753, terminal 22 may obtain the authentication information associated with target device 10. In some embodiments, terminal 22 may send a request for authentication information to management server 30 via secured network 90. The request may include the MAC address of target device 10. As described in connection with methods 300-600, the authentication information may be in the form of an authentication pin or token, and may be saved in database 40. In response to the request for authentication information, management server 30 may retrieve, from database 40, the authentication pin or token associated with the MAC address, and return the retrieved authentication pin or token to terminal 22 via secured network 90.

In some embodiments, as an additional security measure, terminal 22 may obtain the authentication information associated with target device 10 through an out-of-band channel. The out-of-band channel is an information source other than management server 30. In one embodiment, terminal 22 may obtain the authentication pin or token from another terminal, e.g., terminal 20. For example, terminal 22 may receive the authentication pin or token from terminal 20 via NFC or Bluetooth® communication. In some embodiments, provisioning of the authentication information may be completely offline. For example, terminal 20 may generate a two-dimensional quick response (QR) code encoding the authentication pin or token, terminal 22 may then scan the QR code and extract the authentication pin or token from the QR code. As another example, terminal 22 may prompt a user to call the administrator of management server 30 to verify the authentication pin or token. In yet another embodiment, if the authentication pin or token is in numeric and/or alphabetic forms, terminal 22 may prompt the user to manually enter the authentication pin or token into terminal 22.

In step 755, terminal 22 may generate a pairing request using the authentication pin or token. The paring request may include the authentication pin or token, and identification information of terminal 22 (e.g., a unique ID of the management agent in terminal 22). In some embodiments, to add an extra layer of data security, the pairing request may be a pin generated based on the authentication pin/token, and/or identification information of terminal 22.

Subsequently, terminal 22 may transmit the pairing request to target device 10. In response to receiving the pairing request (step 713), target device 10 may return a pairing-authorization response to terminal 22 (step 715). After receiving the pairing-authorization response, terminal 22 may recognize that it has been successfully paired with target device 10 (step 757).

Upon the success of pairing, target device 10 may verify the received authentication pin or token (step 717). If the received authentication pin or token matches the authentication pin or token of target device 10, target device 10 may return a discovery-confirmation message to terminal 22, confirming terminal 22 has successfully discovered target device 10.

Upon receiving the discovery-confirmation message (step 759), terminal 22 may enroll target device 10 in the management agent of terminal 22, such that terminal 22 may manage target 10 using the authentication pin or token.

It will be apparent to those skilled in the art that various modifications and variations can be made to the disclosed systems and methods. Other embodiments will be apparent to those skilled in the art from consideration of the specification and practice of the disclosed systems and methods. It is intended that the specification and examples be considered as exemplary only, with a true scope being indicated by the following claims and their equivalents.

What is claimed is:

1. An authentication method for a first device, the method comprising:
broadcasting, via a communication network, a connection token;
receiving, via the communication network, a pairing request from a second device receiving the connection token;
providing, via the communication network, identification information of the first device to the second device; and
receiving, from the second device, an authentication token generated based on the identification information of the first device.

2. The authentication method of claim 1, wherein the identification information of the first device includes a Media Access Control (MAC) address of the first device.

3. The authentication method of claim 1, wherein receiving the authentication token further includes receiving identification information of a management agent on the second device.

4. The authentication method of claim 1, wherein the authentication token is a trust pin generated by the second device.

5. The authentication method of claim 1, wherein the authentication token is a trust token generated by a management server.

6. The authentication method of claim 5, wherein the identification information of the first device is forwarded to the management server by the second device and the trust token is sent by the management server to the second device for providing to the first device.

7. The authentication method of claim 6, wherein the identification information of the first device is forwarded to the management server by the second device via a secured communication channel.

8. The authentication method of claim 5, further comprising:
sending a request to the management server, wherein the request includes a message digest generated based on the authentication token.

9. The authentication method of claim 5, wherein the management server is in the cloud.

10. The authentication method of claim 1, further comprising generating a message digest based on the authentication token.

11. The authentication method of claim 1, wherein the pairing request from the second device includes a random pin.

12. The authentication method claim 1, further comprising:
broadcasting a service of the first device;
receiving a pairing request from a third device, wherein the paring request includes a pin generated based on the authentication token;
authenticating the paring request from the third device; and
pairing the first device with the third device.

13. The authentication method of claim 11, wherein the service of the first device is broadcasted using a multicast Domain Name System (MDNS).

14. The authentication method claim 11, wherein the pin is generated by the second device and provided to the third device through an out-of-band channel.

15. A system, comprising:
a memory configured to store a set of instructions; and
a processor configured to execute the set of instructions to perform an authentication method for a first device connected with a second device via a communication network, the authentication method comprising:
broadcasting, via the communication network, a connection token;
receiving, via the communication network, a pairing request from a second device receiving the connection token;
providing, via the communication network, identification information of the first device to the second device; and
receiving, from the second device, an authentication token generated based on the identification information of the first device.

16. A non-transitory computer-readable medium storing instructions which, when executed, cause one or more processors to perform an authentication method for a first device, the method comprising:
broadcasting, via a communication network, a connection token;
receiving, via the communication network, a pairing request from a second device receiving the connection token;
providing, via the communication network, identification information of the first device to the second device; and
receiving, from the second device, an authentication token generated based on the identification information of the first device.
